(19) United States
(12) Patent Application Publication
(10) Pub. No.: US 2025/0132440 A1
(43) Pub. Date: Apr. 24, 2025

(54) WELDING SYSTEM

(71) Applicant: GM Global Technology Operations LLC, Detroit, MI (US)

(72) Inventors: William P. Payne, Macomb, MI (US); Hui-Ping Wang, Troy, MI (US); Vivian Vasquez, St. Clair Shores, MI (US); Lu Huang, Troy, MI (US)

(73) Assignee: GM Global Technology Operations LLC, Detroit, MI (US)

(21) Appl. No.: 18/493,671

(22) Filed: Oct. 24, 2023

(51) Int. Cl. H01M 50/244; B23K 37/047; H01M 50/224; H01M 50/249

(52) U.S. Cl. CPC H01M 50/244; B23K 37/047; H01M 50/224; H01M 50/249; H01M 2220/20

(57) ABSTRACT

A battery casing includes a first portion including a first planar portion and a bottom portion and a second portion having a second planar portion, a first side portion, and a second side portion, the first portion and the second portion configured to be welded together at (i) a first butt joint extending along the first side portion to join the first side portion to the first planar portion and to the bottom portion at the first side portion, (ii) a second butt joint extending along the second planar portion to join the second planar portion to the bottom portion at the second planar portion, and (iii) a third butt joint extending along the second side portion to join the second side portion to the first planar portion and to the bottom portion at the second side portion.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a welding system.

Many vehicles are now electric vehicles. For example, all-electric vehicles (EV) incorporate powertrains that are powered solely by one or more electric motors that draw electricity from a battery pack. Hybrid electric vehicles (HEV) also incorporate drivetrains that are powered by one or more electric motors that draw electricity from a battery pack but also include an internal combustion engine (ICE).

Each battery includes a plurality of battery cells. For safety reasons, each battery cell must be hermetically sealed using a battery casing. To ensure repeatability and consistency of production of the battery casing, the battery casing is often formed using deep drawing or extrusion to avoid seams. However, both the deep drawing process and the extrusion process place limitations on the dimensions (i.e., thickness, depth) of the battery casing and also require expensive tooling. As such, a need remains for a battery casing that ensures hermetic sealing without these drawbacks.

### SUMMARY

In one configuration, a battery casing for a vehicle battery cell is provided and includes a first portion including a first planar portion and one or more of a top portion and a bottom portion extending from an end of the first planar portion and a second portion coupled to the first portion and having a second planar portion, a first side portion, and a second side portion disposed opposite the first side portion, the first portion and the second portion forming a prism including the first planar portion, the second planar portion, the first side portion, the second side portion, and one or more of the top portion and the bottom portion. The first portion and the second portion are configured to be welded together at (i) a first butt joint extending along the first side portion to join the first side portion to the first planar portion and to one of the top portion and the bottom portion at the first side portion, (ii) a second butt joint extending along the second planar portion to join the second planar portion to the one of the top portion and the bottom portion at the second planar portion, and (iii) a third butt joint extending along the second side portion to join the second side portion to the first planar portion and to the one of the top portion and the bottom portion at the second side portion.

The battery casing may include one or more of the following optional features. For example, the one of the top portion and the bottom portion may be integrally formed with the first planar portion. Additionally or alternatively, the one of the top portion and the bottom portion may extend from the first planar portion at an angle equal to substantially 90 degrees (90°). Further, the first side portion and the second side portion may be integrally formed with the second planar portion. Additionally or alternatively, the first side portion and the second side portion may extend from the second planar portion at an angle equal to substantially 90 degrees (90°).

In some examples, the prism is hermetically sealed. Additionally, in some examples, the first portion has a thickness of approximately 0.3-1.2 mm. In some examples, the first portion has a thickness of approximately 0.4-1.0 mm. In some examples, the second portion has a thickness of approximately 0.3-1.2 mm. The first portion and the second portion may be comprised of one or more of aluminum or steel. A vehicle may incorporate a rechargeable energy storage system that includes a plurality of rows and columns of the battery casings.

In one configuration, a welding system is provided and includes a rotatable welding fixture configured to secure a first portion and a second portion, the first portion and the second portion forming a prism. The welding system also includes a welding tool configured to secure the first portion and the second portion. Additionally, the rotatable welding fixture is configured to rotate between a first position, a second position, and a third position while the welding tool maintains a downward orientation. In some examples, the welding tool is configured only for translational motion. Additionally, in some examples, the second position is disposed approximately 90 degrees (90°) from the first position. In some examples, the third position is disposed approximately 90 degrees (90°) from the second position. In some examples, the welding tool is configured to secure the first portion and the second portion using butt welds. Additionally, the welding tool may be configured to hermetically seal the prism. In some examples, a battery casing is produced using the welding system. A vehicle may incorporate a rechargeable energy storage system that includes a plurality of rows and columns of the battery casing.

In another configuration, a welding system for a prismatic casing is provided and includes a welding fixture including a first support configured to support an outside surface of a component to be welded. Additionally, the welding fixture includes a second support configured to support an inside surface of the component to be welded. Moreover, the welding system includes one or more clamps configured to secure the component to be welded to the welding fixture. In some examples, the clamps couple the component to be welded to the welding fixture through surface contact. Additionally, the welding fixture may be a rotary fixture configured to move between a first position, a second position, and a third position. In some examples, the second position is disposed approximately 90 degrees (90°) from the first position and the third position is disposed approximately 90 degrees (90°) from the second position. In some examples, a battery casing for a vehicle is produced using the welding system. A vehicle may incorporate multiple rows and columns of battery cells with casings within a battery tray, thereby forming a battery pack (i.e., a rechargeable energy storage system).

In yet another configuration, a method is provided and includes positioning a first component relative to a second component to form a prism having a first side, a second side, and a third side and maintaining the relative position of the first component and the second component in a fixture. The method also includes abutting the first component against the second component at the first side to create a first butt joint at the first side, abutting the first component against the second component at the second side to create a second butt joint at the second side, and abutting the first component against the second component at the third side to create a third butt joint at the third side. The fixture is rotated relative to a welding tool into a first position, the first side opposing the welding tool in the first position and the welding tool is moved along a longitudinal axis to weld the first component and the second component together at the first butt joint. Finally, the method includes rotating the fixture relative to the welding tool into a second position, the second side opposing the welding tool in the second position, moving the welding tool along a longitudinal axis to weld the first component and the second component together at the second butt joint, rotating the fixture relative to the welding tool into a third position, the third side opposing the welding tool in the third position, and moving the welding tool along a longitudinal axis to weld the first component and the second component together at the third butt joint.

Rotating the welding tool into the second position may include rotating the welding tool 90 degrees (90°) from the first position. Further, rotating the welding tool into the third position may include rotating the welding tool 90 degrees (90°) from the second position. Additionally or alternatively, maintaining the relative position of the first component and the second component in a fixture may include clamping at least one of the first component and the second component.

The prism may be incorporated into a rechargeable energy storage system.

### BRIEF DESCRIPTION OF THE DRAWINGS

The drawings described herein are for illustrative purposes only of selected configurations and are not intended to limit the scope of the present disclosure.

FIG. 1 is an exterior view of a vehicle having a rechargeable energy storage system having components produced using a welding system according to the present disclosure;

FIG. 2 is a perspective view of an exemplary rechargeable energy storage system including a plurality of rows and columns of battery casings produced using the welding system according to the present disclosure;

FIG. 3 is a schematic view of a first portion and a second portion of a battery casing being coupled together according to the present disclosure;

FIG. 4A is a front perspective view of a battery casing prior to being joined according to the present disclosure;

FIG. 4B is a front perspective view of a battery casing according to the present disclosure;

FIG. 4C is a rear perspective view of the battery casing of FIG. 4B;

FIG. 4D is a close-up of joints of the battery casing of FIG. 4B;

FIG. 5 is a schematic view of the welding system coupling the battery casing according to the present disclosure;

FIG. 6 is a front perspective view of a welding fixture in accordance with the principles of the present disclosure prior to components of a battery casing being loaded; and

FIG. 7 is a front perspective view of the welding fixture of FIG. 6 when loaded with components for forming a battery casing.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises.” “comprising,” “including,” and “having.” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code: memory (shared, dedicated, or group) that stores code executed by a processor: other suitable hardware components that provide the described functionality: or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data. e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

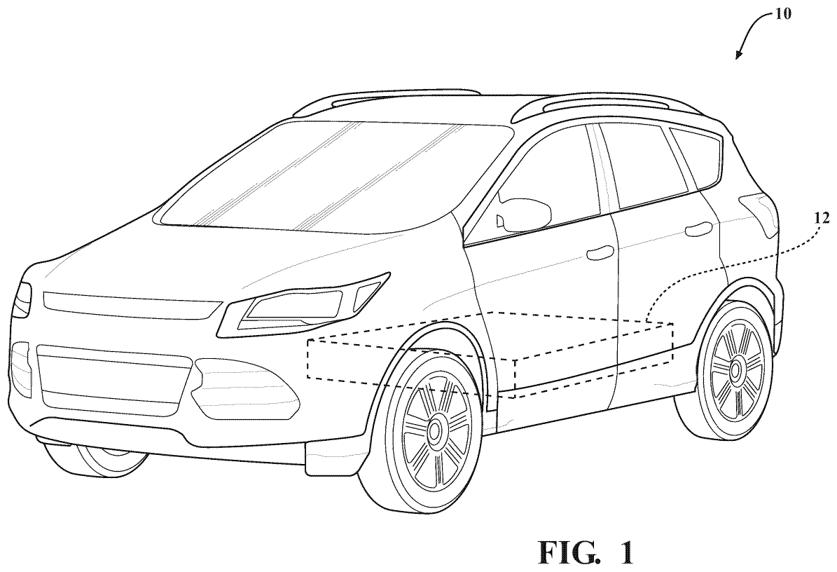

Referring now to the example shown in FIGS. 1-7, a vehicle including a rechargeable energy storage system 12 having one or more components produced using the welding system 30 as described herein, is illustrated at 10 in FIG. 1. The vehicle 10 may be an electric vehicle (EV) and may include autonomous or semi-autonomous capabilities. Additionally or alternatively, the vehicle 10 may be a hybrid vehicle incorporating both EV and internal combustion engine (ICE) components and capabilities.

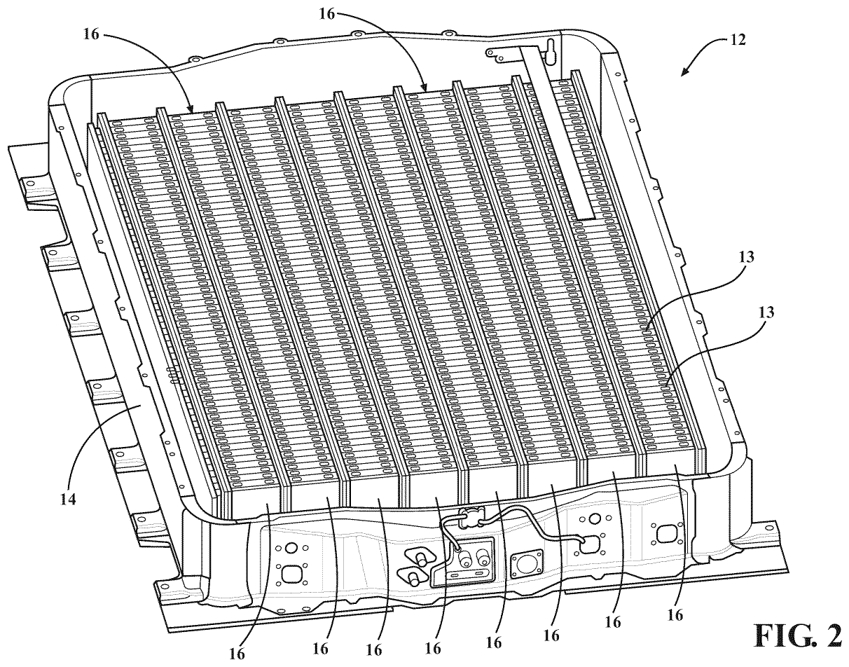

In some examples, the rechargeable energy storage system 12 consists of a battery tray 14 and a plurality of rows and columns of vehicle battery cells encompassed within a battery casing 16, as shown in the example of the rechargeable energy storage system 12 illustrated in FIG. 2. More specifically, the battery casing 16 is configured to house one or more vehicle battery cells (none shown), such as jelly roll units, configured to provide power to the vehicle 10 collectively with other vehicle battery cells inside the battery tray 14. However, it is also contemplated that the battery casing 16 may be configured to house other types of components. Additionally, in some examples, the battery casing 16 may be configured to be hermetically sealed such that the jelly roll unit(s) or other components are completely protected from fluids or other contaminants. The battery casing 16 may additionally include a vent 13 or venting system to allow some air flow into and out of the battery casing 16.

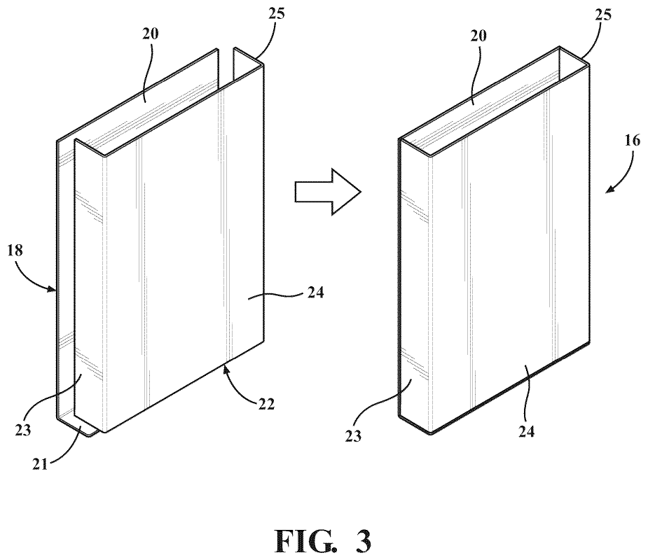

Referring now to the example shown in FIG. 3, the battery casing 16 may include a first portion 18 including a first planar portion 20 and a second portion 22 including a second planar portion 24. As shown in FIG. 3, the first portion 18 and the second portion 22 are single, individual folded sheets. In the example shown, the first planar portion 20 is generally flat and has a generally rectangular shape. However, it is also contemplated that the planar portion may have offset features, protrusions, indentations, or other features, as desired. For example, the first portion 18 may include one or more of a top portion or a bottom portion disposed perpendicular to the first planar portion 20 and extending therefrom. In the example shown, the first portion 18 includes only a bottom portion 21 that is integrally formed with the first portion 18 and, in one configuration, bent into the configuration shown in FIG. 3. The bottom portion 21 may be generally flat and rectangular and, further, may have a smaller size than the first planar portion 20 to form a portion of a rectangular, hollow prism. However, it is contemplated that the bottom portion 21 may be any size and any shape, as desired. Additionally, in some examples, the first portion 18 is comprised of aluminum, steel, or plastic polymer, however, various other materials have been contemplated. Moreover, in some examples, the first portion 18 has a thickness of approximately 0.3-1.2 mm. Additionally, in some examples, the first portion 18 has a thickness of approximately 0.4-1.0 mm. Moreover, in some examples, the first portion 18 has a thickness of approximately 0.5-0.8 mm. However, various other thicknesses have been contemplated. In some examples, the thickness is generally consistent throughout the first portion 18, however, having varying thickness has also been contemplated.

Referring still to the example shown in FIG. 3, the battery casing 16 may include the second portion 22 having the second planar portion 24. In the example shown, the second planar portion 24 is generally flat and has a rectangular shape. However, it is also contemplated that the planar portion may have offset features, protrusions, indentations, or other features as desired. In some examples, the second portion 22 also includes one or more of a first side portion 23 or a second side portion 25 disposed perpendicular to the second planar portion 24 and extending therefrom. The first side portion 23 and the second side portion 25 are disposed opposite one another across the second planar portion 22 and are integrally formed with the second planar portion 22. In one configuration, the first side portion 23 and the second side portion 25 are bent into the configuration shown in FIG. 3 and extend from the second planar portion 22 to an extent substantially equal to the extent the top portion or the bottom portion 21 extends from the first planar portion 20.

In the example shown, the first and second side portions 23, 25 are generally flat, rectangular, and have a smaller size than the second planar portion 24. However, it is contemplated that the first and second side portions 23, 25 may be any size any shape, as desired. Additionally, in some examples, the second portion 22 is comprised of aluminum, steel, or plastic polymer, however, various other materials have been contemplated. Moreover, in some examples, the second portion 22 has a thickness of approximately 0.3-1.2 mm. Additionally, in some examples, the second portion 22 has a thickness of approximately 0.4-1.0 mm. Moreover, in some examples, the second portion 22 has a thickness of approximately 0.5-0.8 mm. However, various other thicknesses have been contemplated. In some examples, the thickness is generally consistent throughout the second portion 22, however, having varying thickness has also been contemplated. Additionally, in some examples, the thickness of the first portion 18 and the second portion 22 are the same, however, varying thickness has also been contemplated.

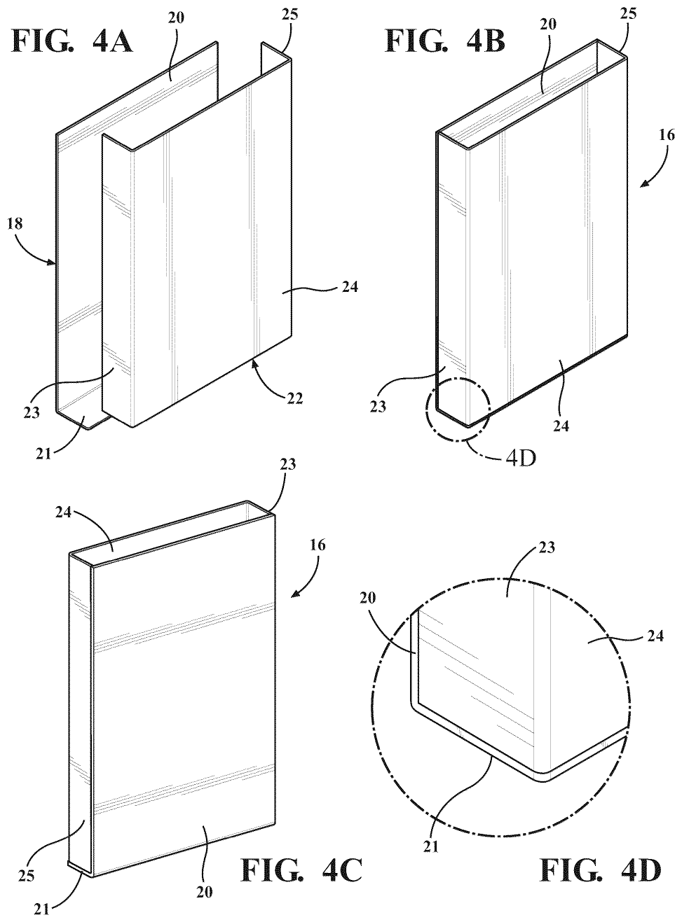

Referring now to the examples shown in FIGS. 3 and 4, the first portion 18 and the second portion 22 form a prism including the first planar portion 20, the second planar portion 24, the first side portion 23, the second side portion 25 disposed opposite the first side portion 23, and the bottom portion 21. The prism may be a rectangular prism, or another shaped prism including, but not limited to, a triangular prism, a square prism, a pentagonal prism, or a hexagonal prism. Additionally, the first portion 18 and the second portion 22 are hermetically sealed to form the battery casing 16 such that a jelly roll or other component(s) located inside the battery casing 16 is completely protected from fluids or other contaminants once a top portion is added. Because the first side portion 23 and the second side portion 25 extend from the second planar portion 22 to an extent substantially equal to the extent the top portion or the bottom portion 21 extends from the first planar portion 20, when the first portion 18 and the second portion 22 are positioned together, as shown in FIG. 3, edges of the first side portion 23 and the second side portion 25 are in contact with the first planar portion 20 and an edge of the bottom portion 21 is in contact with the second planar portion 24.

Additionally, in the example shown in FIGS. 3 and 4, to facilitate the hermetic sealing of the battery casing 16, the first portion 18 and the second portion 22 are configured to be welded together using a plurality of butt welds. A joint for the butt weld is formed by placing two components, such as the first portion 18 and the second portion 22, end-to-end and then welding along the joint. Importantly, in a butt joint, the surfaces of the components, such as the first portion 18 and the second portion 22, are joined on the same plane and weld material remains within the planes of the surfaces. Thus, the components, such as the first portion 18 and the second portion 22, are generally parallel and do not overlap. Additionally, in some examples, the butt weld is a single side partial penetration weld throughout the butt weld. However, it is also contemplated that the butt weld may be a single sided full penetration weld, a double sided full penetration weld, a double sided partial penetration weld, or a combination thereof. Moreover, it is also contemplated that the first portion 18 and the second portion 22 may be coupled using another method including, but not limited to, tee joint welding, corner joint welding, lap joint welding, or edge joint welding.

Additionally, as best illustrated in FIGS. 4A-4D, each of the butt joints face the same direction at any given side of the battery casing 16. For example, on the side of the battery casing 16 substantially defined by the first side portion 23, a butt joint extends along an interface between the first side portion 23 and the first planar portion 20 and along an interface between the first side portion 23 and the bottom portion 21 at the first side portion 23. In a similar fashion, on the side of the battery casing 16 substantially defined by the second side portion 25, a butt joint extends along an interface between the second side portion 25 and the first planar portion 20 and along an interface between the second side portion 25 and the bottom portion 21 at the second side portion 25. Finally, a butt joint extends along the bottom portion 21 at an interface between the bottom portion 21 and an end of the second planar portion 24.

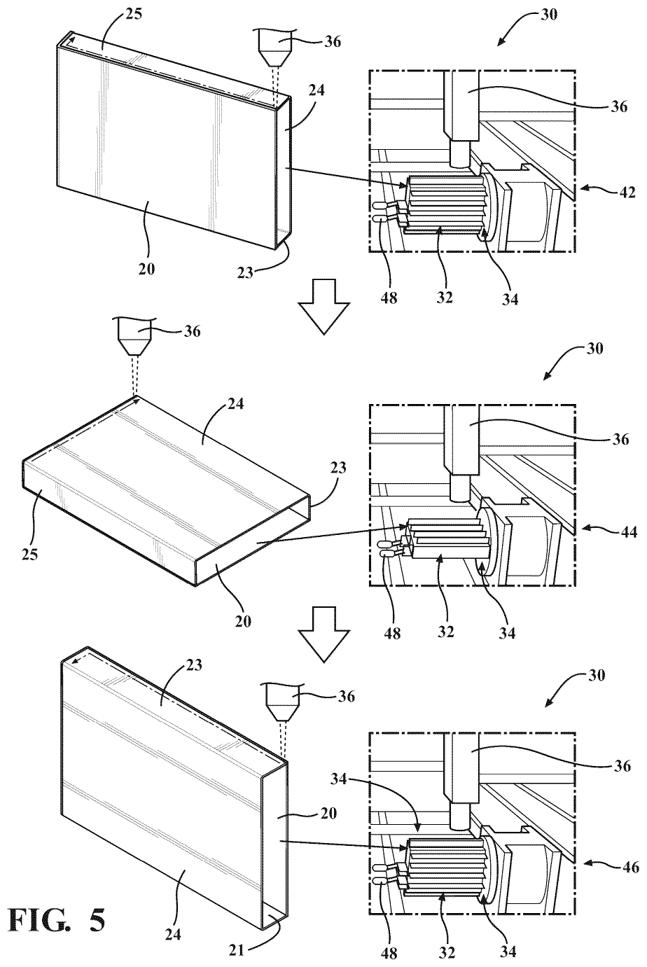

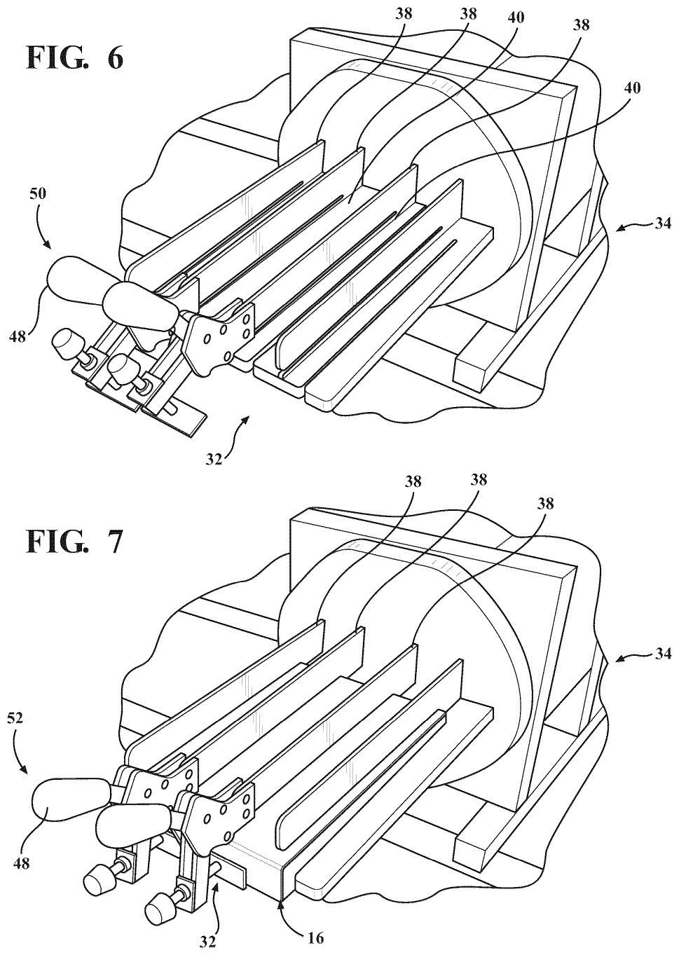

Referring still to the example shown in FIGS. 1-7, the battery casing 16 is produced using the welding system 30. As best shown in FIGS. 5-7, the welding system 30 includes a welding fixture 32 including a rotary portion 34 configured to move in conjunction with the welding tool 36. Additionally, the welding fixture 32 is configured to secure the first portion 18 and the second portion 22 during welding operations. In some examples, the welding fixture 32 includes a first support 38 configured to support an outside surface of the components to be welded, such as the first portion 18 and the second portion 22, and a second support 40 configured to support an inside surface of the components to be welded, such as the first portion 18 and the second portion 22. In the example shown, the welding fixture 32 includes four (4) first supports 38 configured to support the outside surface of the components to be welded, such as the first portion 18 and the second portion 22. While the welding fixture 32 is described and shown as including four (4) supports, the welding fixture 32 could have fewer or more first supports 38. Additionally, in the example shown, the welding fixture 32 includes three second supports 40 configured to support the inside surface of the component to be welded (see FIG. 6) disposed generally perpendicular to the supports 38 and configured to support the inside surface. However, any number and configuration of the second supports 40 configured to support the inside surface of the components to be welded, such as the first portion 18 and the second portion 22, may be utilized. Additionally, in the example shown, the first and second supports 38, 40 are generally rectangular, having a size configured to support the desired component. Utilizing first and second supports 38, 40 in this configuration, prevents thermal distortion and part movement during the welding process.

In use, the welding fixture 32 receives the first portion 18 and the second portion 22 in the position shown in FIG. 3, whereby the first portion 18 and the second portion 22 cooperate to form a prism. In this position, one end of the prism is open and at least partially receives the second supports 40 therein. Further, and as shown in FIG. 7, when the first portion 18 and the second portion 22 are received by the welding fixture 32, a portion of the first side portion 23 and the second side portion 25 are received within respective longitudinal grooves formed into the second supports 40. The prism—defined by the first portion 18 and the second portion 22—may be moved into the position shown in FIG. 7 relative to the second supports 40) until the open end of the prism contacts a plate of the rotary portion 34. At this point, the first supports 38 may be moved into contact with one of the first portion 18 and the second portion 22 to hold the first portion 18 in a desired position relative to the second portion 22.

As best illustrated in FIG. 5, the welding fixture 32 is configured to rotate between positions to assist the coupling of the first portion 18 and the second portion 22 using the rotary portion 34. In the example shown, the welding fixture 32 is configured to rotate between a first position 42, a second position 44, and a third position 46 while the welding tool 36 maintains a downward orientation. However, it is also contemplated that the welding fixture 32 may be configured to rotate between any number of positions. Additionally, in the example shown, the second position 44 is disposed approximately 90 degrees (90°) from the first position 42, such that the welding fixture 32 rotates approximately 90 degrees (90°) between the first position 42 and the second position 44. Moreover, in the example shown, the third position 46 is disposed approximately 90 degrees (90°) from the second position 44, such that the welding fixture 32 rotates approximately 90 degrees (90°) between the second position 44 and the third position 46. Additionally, in the example shown, the third position 46 is approximately 180 degrees (180°) from the first position 42, such that the welding fixture 32 rotates approximately 180 degrees (180°) between the first position 42 and the third position 46. However, it is also contemplated that the first position 42, the second position 44, and the third position 46 may be any rotary distance from one another. Moreover, it is contemplated that the rotary distance between the first position 42 and the second position 44 may or may not be the same as the rotary distance between the second position 44 and the third position 46.

In some examples, the welding system 30 also includes one or more clamps 48 configured to secure the component to be welded to the welding fixture 32. In some examples, the clamps 48 are configured to move between an open position (see FIG. 6) configured to allow the components to be welded, such as the first portion 18 and the second portion 22, to be loaded thereon and a closed position (see FIG. 7) configured to secure the components, such as the first portion 18 and the second portion 22, to the welding fixture 32. Additionally, in some examples, the clamps 48 couple the components to be welded, such as the first portion 18 and the second portion 22, to the welding fixture 32 through surface contact instead of point contact. By only using surface contact, this configuration prevents localized stresses and part distortion to the components to be welded, such as the first portion 18 and the second portion 22, during the welding process. In some examples, the surface contact is defined as having contact area of no less than 5 mm×5 mm. However, various other configurations have also been contemplated including, but not limited to, a contact area of no less than 4 mm×4 mm, no less than 3 mm×3 mm, and no less than 2 mm×2 mm.

Referring again to the example shown in FIG. 5, the welding fixture 32 is configured to be used in conjunction with the welding tool 36 to couple the first portion 18 and the second portion 22. In the example shown, the welding tool 36 is a laser welder. However, it is also contemplated that other types of welding tools may be used, including, but not limited to arc, metal inert gas (MIG), or tungsten inert gas (TIG) welding tools. Additionally, in some examples, the welding tool 36 is configured only for translational motion. As such, the welding tool 36 maintains a downward orientation to ensure consistent and repeatable hermetic sealing qualities to the battery casing 16.

Referring still to the example shown in FIGS. 5-7, in operation, the first portion 18 and the second portion 22 are loaded onto the welding fixture 32 and the clamps 48 are moved from the open position (see FIG. 6) to the closed position (see FIG. 7) where the clamps 48 engage an outer surface of the first portion 18 and/or the second portion 22 and secure the first portion 18 and the second portion 22 to the welding fixture 32. When loaded, the welding fixture 32 may already be in the first position 42 or may move to the first position 42 adjacent the welding tool 36 such as the laser welder. The welding tool 36 is disposed in a downward position and welds the joints of the first portion 18 and the second portion 22 using butt joints and partial penetration welding. When desired, the welding fixture 32 will rotate from the first position 42 to the second position 44 while the welding tool 36 remains in the downward position, only moving translationally. Once the welds are completed in the second position 44, the welding fixture 32 will rotate from the second position 44 to the third position 46 where the remaining welds will be completed. Again, the welding tool 36 remains in the downward position and only moves translationally to form the butt joints in each of the positions of the welding fixture 32. When the welds are completed, the clamps 48 can be moved back to the open position and the battery casing 16 is unloaded. Due to the simple movement of the welding fixture 32 and the welding tool 36, this process is easily repeatable and reliable to produce consistent hermetically sealed battery casings 16.

The welds are formed at the butt joint extending along the interface between (i) the first side portion 23 and the first planar portion 20 at the first side portion 23, (ii) the first side portion 23 and the bottom portion 21 at the first side portion 23, (iii) the second side portion 25 and the first planar portion 20 at the second side portion, (iv) the second side portion 25 and the bottom portion 21 at the second side portion 25, and (v) the bottom portion 21 and an end of the second planar portion 24 at the second planar portion. Each of these weld locations and the accompanying rotational positions of the welding fixture 32 is shown in FIG. 5.

Typical battery casings formed by deep drawing or extrusion provide a consistent hermetically sealed battery casing but require an expensive tooling investment and also suffer from limitations of shape and size due to the forming process. The welding system 30 as described herein produces a consistent sealed battery casing 16 and offers the flexibility in size and shape that comes with the welding process. By forming each of the joints as butt joints facing the same direction, the welding tool 36 can maintain a downward angle eliminating variations in penetration depth. As such, welding process consistency is maintained.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery casing for a vehicle battery cell, the battery casing comprising:
a first portion including a first planar portion and one or more of a top portion and a bottom portion extending from an end of the first planar portion; and
a second portion coupled to the first portion and having a second planar portion, a first side portion, and a second side portion disposed opposite the first side portion, the first portion and the second portion forming a prism including the first planar portion, the second planar portion, the first side portion, the second side portion, and one or more of the top portion and the bottom portion; and
wherein the first portion and the second portion are configured to be welded together at (i) a first butt joint extending along the first side portion to join the first side portion to the first planar portion and to one of the top portion and the bottom portion at the first side portion, (ii) a second butt joint extending along the second planar portion to join the second planar portion to the one of the top portion and the bottom portion at the second planar portion, and (iii) a third butt joint extending along the second side portion to join the second side portion to the first planar portion and to the one of the top portion and the bottom portion at the second side portion.

2. The battery casing of claim 1, wherein the one of the top portion and the bottom portion is integrally formed with the first planar portion.

3. The battery casing of claim 2, wherein the one of the top portion and the bottom portion extends from the first planar portion at an angle equal to substantially 90 degrees (90°).

4. The battery casing of claim 1, wherein the first side portion and the second side portion are integrally formed with the second planar portion.

5. The battery casing of claim 4, wherein the first side portion and the second side portion extend from the second planar portion at an angle equal to substantially 90 degrees (90°).

6. The battery casing of claim 1, wherein the first portion and the second portion are comprised of one or more of aluminum or steel.

7. A vehicle incorporating a rechargeable energy storage system that includes a plurality of rows and columns of the battery casing of claim 1.

8. A welding system comprising:
a rotatable welding fixture configured to secure a first portion and a second portion, the first portion and the second portion cooperating to form a prism; and
a welding tool configured to weld the first portion and the second portion together,
wherein the rotatable welding fixture is configured to rotate between a first position, a second position, and a third position while the welding tool maintains a downward orientation.

9. The welding system of claim 8, wherein the welding tool is configured for translational motion.

10. The welding system of claim 8, wherein the second position is disposed approximately 90 degrees (90°) from the first position.

11. The welding system of claim 8, wherein the third position is disposed approximately 90 degrees (90°) from the second position.

12. The welding system of claim 8, wherein the welding tool is configured to weld the first portion and the second portion together using butt welds.

13. The welding system of claim 8, wherein the welding tool is configured to hermetically seal the prism.

14. A battery casing for a vehicle battery cell produced using the welding system of claim 8.

15. A vehicle incorporating a rechargeable energy storage system including multiple rows and columns of the battery casing of claim 14.

16. A method comprising:
positioning a first component relative to a second component to form a prism having a first side, a second side, and a third side;
maintaining the relative position of the first component and the second component in a fixture;
abutting the first component against the second component at the first side to create a first butt joint at the first side;
abutting the first component against the second component at the second side to create a second butt joint at the second side;
abutting the first component against the second component at the third side to create a third butt joint at the third side;
rotating the fixture relative to a welding tool into a first position, the first side opposing the welding tool in the first position;
moving the welding tool along a longitudinal axis to weld the first component and the second component together at the first butt joint;
rotating the fixture relative to the welding tool into a second position, the second side opposing the welding tool in the second position;
moving the welding tool along a longitudinal axis to weld the first component and the second component together at the second butt joint;
rotating the fixture relative to the welding tool into a third position, the third side opposing the welding tool in the third position; and
moving the welding tool along a longitudinal axis to weld the first component and the second component together at the third butt joint.

17. The method of claim 16, wherein rotating the welding tool into the second position includes rotating the welding tool 90 degrees (90°) from the first position.

18. The method of claim 17, wherein rotating the welding tool into the third position includes rotating the welding tool 90 degrees (90°) from the second position.

19. The method of claim 16, wherein maintaining the relative position of the first component and the second component in a fixture includes clamping at least one of the first component and the second component.

20. The method of claim 16, further comprising incorporating the prism into a rechargeable energy storage system.
